(19) United States
(12) Patent Application Publication
(10) Pub. No.: US 2026/0112522 A1
(43) Pub. Date: Apr. 23, 2026

(54) AUTOCLAVABLE ELECTRICAL FEEDTHROUGH AND GLASS FOR AN AUTOCLAVABLE ELECTRICAL FEEDTHROUGH

(71) Applicant: Schott AG, Mainz (DE)

(72) Inventors: Martun Hovhannisyan, Mainz (DE); Nina Hoinkis, Mainz (DE); Thomas Zetterer, Landshut (DE); Marius Lorenz, Landshut (DE); Julia Hütsch, Landshut (DE)

(73) Assignee: Schott AG, Mainz (DE)

(21) Appl. No.: 19/361,339

(22) Filed: Oct. 17, 2025

(30) Foreign Application Priority Data
Oct. 18, 2024 (DE) 10 2024 130 333.6

(51) Int. Cl. H01B 17/30; H01B 3/08; H01B 7/29; H01B 17/62; H02G 15/013

(52) U.S. Cl. CPC H01B 17/305; H01B 3/087; H01B 7/292; H01B 17/62; H02G 15/013

(57) ABSTRACT

An electrical feedthrough includes: a main body having a through-opening running through the main body and comprising titanium or titanium alloy; an insulation material accommodated in the through-opening, the insulation material comprising a glass; and an electrical conductor that extends through the insulation material accommodated in the through-opening. The glass is a lanthanum borate glass comprising the following components (in mol % based on oxide): 22.0-37.0 B₂O₃; 1.0-12.0 La₂O₃; 10.5-23.0 SiO₂; 29.0-45.0 RO (MgO+CaO+SrO); 0.1-6.0 Nb₂O₅+ZrO₂+TiO₂+Ta₂O₅; and greater than 3.00 SiO₂/(Nb₂O₅+ZrO₂+TiO₂+Ta₂O₅). The glass, on determination of hydrolytic stability in accordance with DIN ISO 720:2021-12, has an Na₂O equivalence value of <1250 μg/g. The feedthrough has long-term autoclaving stability and an insulation resistance of the feedthrough after 300 autoclaving operations is at least 1*10⁹ ohms.

### CROSS REFERENCE TO RELATED APPLICATIONS

This application claims priority to German Patent Application No. 10 2024 130 333.6 filed on Oct. 18, 2025, which is incorporated in its entirety herein by reference.

### BACKGROUND OF THE INVENTION

### 1. Field of the Invention

The invention relates to an autoclavable electrical feedthrough having a metal-comprising main body incorporating a glass-comprising insulation material having an electrical conductor extending through it. The invention further relates to a glass for such an autoclavable electrical feedthrough.

### 2. Description of the Related Art

Electrical feedthroughs with an outer metallic main body and an inner glass component serving as an insulator (glass-metal feedthroughs), through which one or more conductors extend, are used in numerous applications, especially for hermetic wall parts, for instance of housing elements. Corresponding components find use, for example, in the field of medical technology, for example in electrical plug connectors and hermetic housing parts/seals in medical devices, such as in endoscopes and in surgical instruments that are used for examination, operation and treatment and only have brief contact with the body, but can be reused repeatedly for such purposes after appropriate sterilization. One example of a field of use is in robot surgery. Other fields of use are implantable medical devices (IMD), lightweight applications (for example in the aerospace sector) and many other sectors. Depending on the field of use, different profiles of requirements may have to be taken into account, although there are also similarities with regard to the optimization and further development of known solutions.

There are particular requirements with regard to the use of feedthroughs in medical technology devices. It is generally the case in this field that the feedthroughs are provided in a component made of titanium or a titanium alloy. There are particular challenges in respect of sealing of glass in titanium or titanium alloys, since titanium is a highly reactive material. In the case of glasses with high silicate levels, there is the problem that the titanium reacts with SiO₂ to form titanium silicide at the customary sealing temperatures of about 700-900° C. that are necessary for the production of glass-metal feedthroughs, and this reaction is accompanied by blistering at the glass-metal interface. It should also be noted that pure titanium has a phase transition temperature of 880° C. (transition of the low-temperature alpha-titanium polymorph to the high-temperature beta-titanium polymorph). For titanium alloys, e.g. grade 5 titanium (TiAl6V4), this phase transition temperature is higher, but the reaction mechanisms at the interface to the glass are the same. Therefore, the glass compositions have to be optimized with regard to low sealing temperatures in order to be able to implement the seal below the transition reaction which is detrimental to sealing capacity.

In addition, it is generally desirable and an aspect of the object of the invention that devices or components that are usable in medical technology with glass-metal feedthroughs are autoclavable, i.e. sterilizable at high vapour pressure and temperatures >100° C., in order to be able to use the devices repeatedly for diagnoses or treatments on or in the human or animal body or for the examination, for example, of biological material in laboratories, etc. Autoclaving over many cycles or runs, i.e. repeated autoclaving, places a high burden on the materials used and especially on the glass in the feedthroughs. Known glasses that are used in feedthroughs in medical devices have relatively low autoclaving stability; in other words, because of low chemical stability of the glasses, there is a decrease in insulation resistance offered by the glass in the feedthrough after relatively few autoclaving operations, and so the device is no longer usable. In this respect, higher demands are placed on repeatedly used medical devices that do not remain permanently in the body and have to be sterilized many times after use than on implantable medical devices (IMDs), e.g. cardiac pacemakers, defibrillators, pumps, etc.

Moreover, it is generally desirable that the components used do not have a toxic effect when they can come into contact with body fluids at least intermittently or permanently (in the case of implants). In addition to the main body and the electrical conductors, this applies in particular to the glasses (owing to leaching effects), and it may therefore be the case here in particular that leaching tests are conducted in advance, for example before more specific qualification tests for medical devices and implants, for example, are conducted. Modern feedthroughs for medical applications usually contain boron-aluminium silicate glasses. These are often alkali metal-free owing to the requisite high stability to aqueous solutions and have a high content of B₂O₃, Al₂O₃ and alkaline earth metal oxides (CaO, MgO, SrO). In known leaching tests, leaching is generally determined in water, for example by determining the dissolution rate via the weight loss of polished glass samples after a dwell time of two weeks in deionized water at 70° C. (see below). A lower dissolution rate of a sample should correlate with elevated resistance of the glass composition to chemical attacks by moisture, water or aqueous body fluids (i.e. elevated water stability).

However, for autoclavable components with electrical feedthroughs, significantly higher demands are placed on the chemical stability of the glasses. The glasses are subjected to a high degree of stress by steam pressure sterilization at high temperatures (generally between 11° and 140° C.). When hydrolytic stability is low, the continuous leaching-out of glass components during multiple autoclaving runs has the effect that the insulation resistance of the feedthrough drops below a critical level, such that the device can no longer be safely used.

A further requirement on a glass that is to be suitable for feedthroughs in medical devices is the coefficient of thermal expansion, which should be adapted to the metal components used and to the desired type of pressure conditions in the feedthrough.

US2009/0229858A1, US2020/0261732A1 and US2021/0290964A1 disclose an implantable medical device having a glass-metal feedthrough in a titanium component, wherein the glass is an alkaline earth metal-containing boron-aluminium silicate glass and may include fillers for adjusting the coefficient of thermal expansion (CTE). Composite materials are thus disclosed. CTE adjustment is the focus of US2020/0261732A1. US2021/0290964A1 teaches how CTE and modulus of elasticity of the composite are varied by different contents of crystalline filler, explicitly by added Al₂O₃ particles. The resistance of the glasses disclosed therein to steam pressure sterilization at temperatures is poor. However, since implantable medical devices have to withstand only a few sterilization runs before they remain in the body permanently, such glasses are adequate for these applications in spite of their poor hydrolytic stability. However, such glasses are unsuitable for components with feedthroughs that are to be autoclaved several hundred times. This means that the autoclaving stability of the feedthrough with glasses suitable for medical implants does not meet the requirements placed on repeatedly used medical devices that do not remain within the body and have to be sterilized many times after use.

U.S. Pat. No. 5,648,302B discloses a glass composition for a hermetic glass-metal feedthrough comprising titanium and titanium alloys for implanted medical devices with resistance to aqueous solutions (determined in leaching tests with polished glass samples in deionized water at 70° C.). The glass is a barium lanthanum borate glass. Because of the high BaO content of the glass, such glasses are significantly attacked by water at high temperatures (>100° C.), i.e. hydrolytic stability of the glass at high temperatures as exist in autoclaving operations is relatively low, meaning that the glass-metal feedthrough can only be autoclaved a few times (e.g. <100) before insulation resistance becomes inadequate, which is sufficient for implantable applications but not for repeatedly reusable devices, for example in medical technology.

U.S. Pat. No. 5,693,580B discloses a glass composition for a hermetic glass-metal feedthrough comprising titanium and titanium alloys for implanted medical devices with high resistance to aqueous solutions (determined in leaching tests with polished glass samples in deionized water at 70° C.). The glass is a calcium lanthanum borate glass. The glasses disclosed therein do not contain SiO₂ in order to prevent the formation of titanium silicide. These glasses also show low hydrolytic stability at temperatures >100° C., meaning that they are not stable to autoclaving over many runs.

U.S. Ser. No. 10/544,058B1 discloses specific composite materials that include an alkali metal aluminosilicate glass and fillers. Because of the alkali metal content and filler content, which can lead to a certain porosity, such glasses are less suitable for applications that require high autoclaving stability of the feedthroughs.

There are also known implantable medical devices, for example a cochlear implant from US2015/0088226 A, which comprises a sealed housing with electronics and a feedthrough with ceramic as insulation material.

WO2023/016964A describes a feedthrough comprising a main body of titanium or a titanium alloy with a through-opening, a glass as insulation material and at least one electrical conductor, where the glass forms a particular contact angle with the metal parts. The alkali metal aluminosilicate glass disclosed therein has relatively low stability to repeated autoclaving because of the alkali metal content.

### SUMMARY OF THE INVENTION

In general, it is desirable, for example, and what is needed in the art is a way to increase the stability of feedthroughs mentioned at the outset with regard to chemical and/or physical influences and to improve the seal tightness of the insulation material to the surrounding main body and/or to the electrical conductor extending through the insulation material. There is also a need in the art for a way to provide a feedthrough that is repeatedly autoclavable and still retains the required insulation resistance. What is also needed in the art is a way to provide a glass which is suitable for repeated autoclaving, and which is suitable for bonding to a main body made of titanium or a titanium alloy.

In some embodiments provided according to the present invention, an electrical feedthrough includes: a main body having at least one through-opening running through the main body and comprising titanium or titanium alloy; an insulation material accommodated in the at least one through-opening running through the main body, the insulation material comprising a glass; and at least one electrical conductor that extends through the insulation material accommodated in the at least one through-opening. The glass is a lanthanum borate glass comprising the following components (in mol % based on oxide): 22.0-37.0 B₂O₃; 1.0-12.0 La₂O₃; 10.5-23.0 SiO₂; 29.0-45.0 RO (MgO+CaO+SrO); 0.1-6.0 Nb₂O₅+ZrO₂+TiO₂+Ta₂O₅; and greater than 3.00 SiO₂/(Nb₂O₅+ZrO₂+TiO₂+Ta₂O₅). The glass, on determination of hydrolytic stability in accordance with DIN ISO 720:2021-12, has an Na₂O equivalence value of <1250 μg/g. The feedthrough has long-term autoclaving stability and an insulation resistance of the feedthrough after 300 autoclaving operations is at least 1*10⁹ ohms.

In some embodiments provided according to the present invention, a glass for an electrical feedthrough having a main body of titanium or a titanium alloy is provided. The glass is a lanthanum borate glass comprising the following components (in mol % based on oxide): 22.0-37.0 B₂O₃; 1.0-12.0 La₂O₃; 10.5-23.0 SiO₂; 29.0-45.0 RO (MgO+CaO+SrO); 0.1-6.0 Nb₂O₅+ZrO₂+TiO₂+Ta₂O₅; and greater than 3.00 SiO₂/(Nb₂O₅+ZrO₂+TiO₂+Ta₂O₅). The glass, on determination of hydrolytic stability in accordance with DIN ISO 720:2021-12, has an Na₂O equivalence value of <1250 μg/g.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic diagram of an exemplary embodiment of a feedthrough provided according to the present invention;

FIG. 2 is a schematic diagram of another exemplary embodiment of a feedthrough provided according to the present invention; and

FIG. 3 is a schematic diagram of yet another exemplary embodiment of a feedthrough provided according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Exemplary embodiments disclosed herein provide an electrical feedthrough comprising a main body having at least one through-opening running through the main body, and also an insulation material accommodated in the through-opening running through the main body, and at least one electrical conductor that extends through the insulation material accommodated in the through-opening, wherein the main body comprises titanium or a titanium alloy and the insulation material consists of glass or comprises a glass.

The glass is a lanthanum borate glass comprising the following components (in mol % based on oxide):

| | |
|---|---|
| B₂O₃ | 22.0-37.0 |
| La₂O₃ | 1.0-12.0 |
| SiO₂ | 10.5-23.0 |
| RO (MgO + CaO + SrO) | 29.0-45.0 |
| Nb₂O₅ + ZrO₂ + TiO₂ + Ta₂O₅ | 0.1-6.0 |
| SiO₂/(Nb₂O₅ + ZrO₂ + TiO₂ + Ta₂O₅) | >3.00; |

where the glass, on determination of hydrolytic stability in accordance with DIN ISO 720:2021-12, has an Na₂O equivalence value of <1250 μg/g, such that the feedthrough comprising such a glass has long-term autoclaving stability, where an insulation resistance of the feedthrough after 300 autoclaving operations is optionally at least 1*10⁹ ohms.

The inventors have found that, surprisingly, the hydrolytic stability of a lanthanum borate glass to the harsh conditions of autoclaving can be distinctly improved when the glass has a relatively high proportion of SiO₂ for a glass-metal feedthrough comprising titanium or a titanium alloy, and a certain proportion of Nb₂O₅ and/or ZrO₂ and/or TiO₂ and/or Ta₂O₅. These components act individually or in combination—i.e. at least two of these components—as stability enhancers for hydrolytic stability. In other words, the stability enhancer includes at least one component selected from the group comprising Nb₂O₅, ZrO₂, TiO₂, Ta₂O₅. According to the invention, these components are part of the glass, i.e. they are not fillers that are added subsequently. In contrast to a glass or insulation material comprising fillers, the glass provided according to the invention or the insulation material in the feedthrough therefore has only a few pores, which may be advantageous for hermetic seal tightness. A feedthrough comprising such a glass advantageously has long-term autoclaving stability, such that it can be used in a device, component, etc. in medical technology that has to be repeatedly autoclavable. The glass or the insulation material may be free of pores.

The hydrolytic stability of the glass is determined according to DIN ISO 720:2021-12 on ground glass at 121° C., i.e. at similarly high temperatures to those in autoclaving. Ground glass with a defined grain size and surface area is kept in distilled water in the autoclave at 121° C. for 30 min. Stability is measured and expressed by the volume of acid required for titration of the alkali extracted from the mass unit of glass, and can also be expressed by the amount of sodium oxide corresponding to that volume of acid. In the context of the invention, the sodium oxide equivalence value is expressed as the mass of sodium oxide per gramme of ground glass.

The glasses provided according to the invention have an Na₂O equivalence value of <1250 μg/g. Some exemplary embodiments have an Na₂O equivalence value of <1100 μg/g or <1000 μm/g. Some exemplary embodiments have an Na₂O equivalence value of <930 μg/g and should thus be classified in class HGA 3 according to DIN ISO 720:2021-12.—Optionally the glass has an Na₂O equivalence value, such that the feedthrough comprising such a glass has long-term autoclaving stability.

“Long-term autoclaving stability” in the context of the invention means that the feedthrough can be autoclaved at least 300 times at 135.5° C. and a pressure of 2.16 bar for a duration of 20 min while maintaining sufficient insulation resistance. This means that the feedthroughs meet the requirements placed on repeatedly used healthcare equipment, medical devices and laboratory equipment. Stability to repeated autoclaving is determined as described further down in association with the working examples. Reference is made thereto for avoidance of repetition.

The insulation resistance of the feedthrough after 300 or after at least 300 autoclaving operations may advantageously still be at least 1*10⁹ ohms. If the insulation resistance is below this limit, the conductor (also called “pin”) and outer conductor in a feedthrough are no longer sufficiently insulated, and so leakage currents can occur, up to and including short circuits. The minimum insulation resistance mentioned allows safe operation of a device containing the feedthrough according to the invention with long-term autoclaving stability. Feedthroughs that withstand at least 300 autoclaving runs under the abovementioned conditions can also withstand repeated sterilization at higher temperatures and/or higher pressures and/or for longer periods than described above.

The insulation resistance of the feedthrough after at least 600, optionally after at least 900, optionally after at least 1200, autoclaving operations may advantageously still be at least 1×10⁹ ohms, where the sterilization was conducted in each case under the abovementioned conditions (i.e. 135.5 C; 2.16 bar; 20 min).

The insulation resistance, which is a measure of autoclaving stability, is determined according to MIL-STD-883, Meth. 1003, on the feedthrough with the conductor sealed in glass, with the electrodes placed on the main body and on the conductor. The measurement is conducted in each case at one site at room temperature (20° C.) and a humidity under typical laboratory conditions (50%+/−10% relative humidity) with a voltage of 100 V, measurement duration 5 s. For determination of insulation resistance, an electrical feedthrough with the following dimensions is always used in the context of the invention: diameter of the through-opening in the main body that accommodates the insulation material with conductor 1.8 mm, diameter of the conductor 0.5 mm, and sealing length 3.0 mm. Of course, the dimensions may be different in the application.

With regard to hermeticity, it may be advantageously be the case that the feedthrough after 300 or after at least 300 autoclaving runs has a hermeticity characterized by a helium leakage rate of less than 1·10⁻⁸ mbar·l/s, optionally of less than 1·10⁻⁹ mbar·l/s, optionally of less than 1·10⁻⁸ mbar·l/s, determined at a pressure difference of 1 bar. For example, the hermeticity of feedthroughs can be determined by a helium leak test, for example according to MIL-STD-883, Meth. 1014 A4. A helium leakage rate of less than 1·10⁻⁸ mbar·l/s may be advantageously achieved even after at least 600, at least 900, or even at least 1200, autoclaving operations. This means that the insulation material accommodated in the through-opening of the main body is in intimate contact with the main body and/or with the at least one electrical conductor. The glass may melt in the production of the feedthrough and bond to the metal components, so as to provide a permanent, hermetically sealed glass-metal bond.

### Glass Composition

The composition features and exemplary embodiments described hereinafter contribute to the inventive and advantageous properties of the glass. The description applies both to the glass and to a feedthrough comprising such a glass. It has been found that in an alkaline earth metal oxide-containing lanthanum borate glass, in particular by virtue of a defined content of one or more particular components that act as stability enhancers and are glass component(s), and by virtue of a certain proportion of SiO₂, the chemical stability of the glass can be increased in such a way that it can withstand the harsh conditions in the case of repeated autoclaving. In addition, it fulfils other desired advantageous properties, for example with regard to hermetic tightness of the feedthrough, sealing temperature for the production of the feedthrough, thermal expansion, etc.

The sealing temperature for the production of the glass-metal feedthrough may advantageously be ≤950° C., ≤930° C., ≤900° C., or even ≤880° C. The sealing temperature is the temperature at which hermetically sealed feedthroughs can be produced successfully. A measure of the sealing temperature is the hemisphere temperature. Experience has shown that the sealing temperature is roughly the same as the hemisphere temperature or a few degrees higher, for example at least 5° C. or at least 25° C. or at least 50° C. or at least 70° C.

The glass provided according to the invention contains B₂O₃. This component is present in a proportion of 22.0 to 37.0 mol %. B₂O₃ is a glass component that is important for glass formation and hydrolytic stability. In addition, B₂O₃ can form a Ti—B layer with titanium, which leads to more chemically and mechanically stable compounds between titanium-comprising components and the glass. Therefore, this component is present in the glass at at least 22.0 mol % or at least 22.5 mol %. An upper limit of 37.0 mol % should not be exceeded because it would otherwise be necessary to reduce contents of other glass components, in particular alkaline earth metal oxides and/or Al₂O₃, which would lead to a deterioration in desired glass properties, for example to lowering of the coefficient of thermal expansion, a rise in sealing temperature, etc. In some variants, the glass may have a B₂O₃ content of at least 25.0 mol %, at least 27.0 mol %, at least 28.0 mol %. The content in some embodiments may be not more than 37.0 mol % or not more than 35.0 mol %. For some variants, 31.0 mol % or less than 31.0 mol % may also be a suitable upper limit.

The glass provided according to the invention contains La₂O₃ in a proportion of 1.0 to 12.0 mol %. La₂O₃ is a glass component that improves glass flow on melting and lowers the sealing temperature, so that the conductor can be sealed into the main body at lower temperatures. In addition, this component can raise the coefficient of thermal expansion of the glass. For these reasons, this component is present in the glass at at least 1.0 mol %. An upper limit of 12.0 mol % should not be exceeded, because otherwise the sealing temperature is too high. In some embodiments, the glass has an La₂O₃ content of at least 1.5 mol % or at least 2.0 mol %. The content in some embodiments may optionally be not more than 11.0 mol % or not more than 10.0 mol % or not more than 9.0 mol % or not more than 8.0 mol % or less than 8.0 mol %.

The glass provided according to the invention contains SiO₂ with a content of 10.5 to 23.0 mol %. The minimum content should not be less than 10.5 mol %, since hydrolytic stability of the glass and hence autoclaving stability of the feedthrough will otherwise not be achieved. An upper limit of 23.0 mol % should not be exceeded because, as the SiO₂ content increases, there is a rise in the temperatures required for the incorporation of the conductor into the main body, and so there is a risk that the unwanted phase transition (alpha-titanium-beta-titanium) will occur in the titanium or in the titanium alloy of the main body—and possibly the conductor—with the associated adverse changes in properties, or titanium will react with SiO₂ to form titanium silicide. There may be changes in volume and/or bubbles may form in the glass at the interfaces with the metal. In addition, too high a SiO₂ content lowers the coefficient of thermal expansion. In some embodiments, the glass has an SiO₂ content of at least 11.0 mol % or at least 11.5 mol % or at least 12.0 mol %. In some embodiments, the minimum SiO₂ content may be 15.0 mol % or more than 15.0 mol %. For some variants, 15.5 mol % or 16.0 mol % may be a lower limit. The SiO₂ content in some embodiments may optionally be at most 22.5 mol %, at most 22.0 mol %, at most 21.0 mol %, and for some variants at most 20.0 mol %.

The glass provided according to the invention contains a stability enhancer having a content of 0.1 to 6.0 mol %, where the stability enhancer is at least one component selected from the group comprising Nb₂O₅, ZrO₂, TiO₂, Ta₂O₅. The sum of the components Nb₂O₅+ZrO₂+TiO₂+Ta₂O₅ should be at least 0.1 mol %, since hydrolytic stability is otherwise insufficiently improved. An advantageous lower limit may also be 0.2 mol % or 0.3 mol %, or for some variants 0.4 mol %. An upper limit of 6.0 mol % should not be exceeded, since there is a rising risk of devitrification, i.e. crystal formation. In addition, the sealing temperature rises as the content increases, with the disadvantages described above for the SiO₂ component. An upper limit for the sum total may also be 5.5 mol % or 5.0 mol % or 4.5 mol %. The stability enhancer is part of the melted glass, i.e. a glass component.

As a stability enhancer, the glass may contain Nb₂O₅ with a content of 0.0 to 6.0 mol %. If the glass is to contain Nb₂O₅, the component may contain at least 0.05 mol % or at least 0.1 mol % or at least 0.2 mol %. In some embodiments, the Nb₂O₅ content is limited to not more than 6.0 mol %, not more than 5.5 mol %, not more than 5.0 mol %, not more than 4.5 mol % or not more than 4.0 mol %. In some embodiments, the glass is free of Nb₂O₅. It may be advantageous to reduce the Nb₂O₅ content or to dispense entirely with Nb₂O₅ in order to prevent crystal formation in the glass and/or a rise in the sealing temperature.

As a stability enhancer, the glass may contain ZrO₂ with a content of 0.0 to 6.0 mol %. If the glass is to contain ZrO₂, the component may contain at least 0.05 mol % or at least 0.1 mol % or at least 0.2 mol %. In some embodiments, the ZrO₂ content is limited to not more than 6.0 mol %, not more than 5.5 mol %, not more than 5.0 mol %, not more than 4.5 mol %, not more than 4.0 mol % or not more than 3.5 mol %. In some embodiments, the glass is free of ZrO₂. It may be advantageous to reduce the ZrO₂ content or to dispense entirely with ZrO₂ in order to prevent crystal formation in the glass and/or an increase in the sealing temperature.

As a stability enhancer, the glass may contain TiO₂ with a content of 0.0 to 6.0 mol %. If the glass is to contain TiO₂, the component may contain at least 0.05 mol % or 0.1 mol % or at least 0.2 mol %. In some embodiments, the TiO₂ content is limited to not more than 6.0 mol %, not more than 5.5 mol %, not more than 5.0 mol %, not more than 4.5 mol % or not more than 4.0 mol %. In some embodiments, the glass is free of TiO₂. It may be advantageous to reduce the TiO₂ content or to dispense entirely with TiO₂ in order to prevent crystal formation in the glass.

As a stability enhancer, the glass may contain Ta₂O₅ with a content of 0.0 to 6 mol %. If the glass is to contain Ta₂O₅, the component may contain at least 0.05 mol % or at least 0.1 mol % or at least 0.2 mol %. In some embodiments, the Ta₂O₅ content is limited to not more than 6.0 mol %, not more than 5.5 mol %, not more than 5.0 mol %, not more than 4.5 mol %, not more than 4.0 mol % or not more than 3.5 mol %. In some embodiments, the glass is free of Ta₂O₅. It may be advantageous to reduce the Ta₂O₅ content or to dispense entirely with Ta₂O₅ in order to keep the sealing temperature low and to prevent crystal formation in the glass.

The glass provided according to the invention contains RO with a content of 29.0 to 45.0 mol %, where RO represents the sum total of the alkaline earth metal oxides MgO+CaO+SrO. Alkaline earth metal oxides can be used to lower the temperature at which the conductor can be sealed into the main body and raise the coefficient of thermal expansion, and therefore at least 29.0 mol % of RO is present. An upper limit of 45.0 mol % should not be exceeded, since the chemical stability of the glass will otherwise deteriorate and there is a risk of crystal formation in the glass (devitrification). In some embodiments, the glass contains at least 30.0 mol % or at least 31.0 mol % of RO. The content may be limited to not more than 42.0 mol % or not more than 40.0 mol % or for some variants not more than 39.5 mol % or not more than 39.0 mol % or not more than 38.0 mol % or not more than 37.0 mol %.

The glass, in some embodiments, may contain MgO with a content of 0.0 to 20.0 mol %, i.e. the MgO content is not more than 20.0 mol %. In some embodiments, the MgO content is limited to not more than 18.0 mol %, not more than 17.0 mol %, not more than 16.0 mol %. If the glass is to contain MgO, it may in some variants contain at least 0.1 mol % or at least 0.2 mol % of MgO. Some variants contain at least 4.0 mol % or at least 5.0 mol % or at least 6.0 mol % of MgO. Some variants may even contain at least 8.0 mol % or at least 9.0 mol % of MgO. It may be advantageous to provide a certain MgO content in addition to CaO and/or SrO in the glass in order to prevent crystal formation in the glass via the combination. An exemplary range for MgO may be 6.0 to 18.0 mol %. In some embodiments, the glass may be free of MgO.

The glass, in some embodiments, may contain CaO with a content of 0.0 to 20.0 mol %, i.e. the CaO content is not more than 20.0 mol %. In some embodiments, the CaO content is limited to not more than 19.0 mol % or not more than 18.0 mol % or, for some variants, not more than 17.0 mol %. If the glass is to contain CaO, it may in some variants contain at least 0.1 mol % or at least 0.2 mol % of CaO. Some variants contain at least 5.0 mol % or at least 7.0 mol % or at least 10.0 mol % of CaO. It may be advantageous to provide a certain CaO content in addition to MgO and/or SrO in the glass in order to prevent crystal formation in the glass via the combination. An exemplary range for CaO may be 10.0 to 20.0 mol %. In some embodiments, the glass may be free of CaO.

The glass, in some embodiments, may contain SrO with a content of 0.0 to 10.0 mol %, i.e. the SrO content is not more than 10.0 mol %. In some embodiments, the SrO content is limited to not more than 9.0 mol % or not more than 8.0 mol %. If the glass is to contain SrO, it may in some variants contain at least 0.1 mol % or at least 0.2 mol % of SrO. Some variants contain at least 2.0 mol % or at least 3.0 mol % or at least 4.0 mol % of SrO. It may be advantageous to provide a certain SrO content in addition to MgO and/or CaO in the glass in order to prevent crystal formation in the glass via the combination. An exemplary range for SrO may be 3.0 to 8.0 mol %. In some embodiments, the glass may be free of SrO.

In order to reduce the risk of devitrification, the glass contains at least two alkaline earth metal oxides in any combination, selected from the group consisting of MgO, CaO and SrO. The glass optionally contains MgO and CaO and SrO.

The glass may contain 0.0 to not more than 1.5 mol % of BaO. This limit should not be exceeded since this component can reduce the hydrolytic stability of the glass, such that the feedthrough no longer has long-term autoclaving stability to the desired extent. The glass may contain not more than 1.0 mol %, optionally not more than 0.5 mol %, optionally not more than 0.1 mol % of BaO. The glass is optionally free of BaO.

The glass in some embodiments may contain fractions of ZnO, in particular 0.0 mol % up to a maximum of or less than 5.0 mol %. The content should be limited to not more than 5.0 mol %, since the component has an adverse effect on the hydrolytic stability of the glass. An exemplary upper limit may also be not more than 3.0 mol % or not more than 2.0 mol %. If ZnO is to be present in the glass, at least 0.1 mol % or at least 0.2 mol % or at least 0.5 mol % may be an exemplary lower limit. Some variants of the glass may be free of ZnO.

The glass may contain Al₂O₃ in order to increase hydrolytic stability, increase the coefficient of thermal expansion and reduce the tendency to crystallization. The proportion of Al₂O₃ in the glass composition may be at least 3.0 mol %, optionally at least 7.0 mol %, optionally at least 8.0 mol %, optionally at least 9.0 mol %. An exemplary upper limit may be not more than 20.0 mol %, not more than 17.0 mol %, not more than 16.0 mol %. The upper limit should not be exceeded, because the risk of crystallization and/or the sealing temperature will otherwise increase. For some variants, an upper limit may be not more than 15.0 mol % or not more than 14.0 mol % or not more than 13.0 mol %. An exemplary range may be 7.0 mol % to 17.0 mol % or 7.0 to <15.0 mol %, optionally 8.0 to 14.0 mol %.

In some embodiments, the glasses provided according to the invention have low levels of alkali metals, and are optionally free of alkali metals, since alkali metal ions reduce the chemical stability, in particular the hydrolytic stability, of the glass and are thus detrimental to long-term autoclavability. What is meant by “low levels of alkali metals” in the context of the present invention is that the sum total of the alkali metal oxides R₂O (Li₂O+Na₂O+K₂O+Cs₂O+Rb₂O) in the glass is not more than or less than 3.0 mol %, not more than 2.0 mol %, not more than 1.0 mol %, not more than or less than 0.5 mol %, optionally not more than or less than 0.1 mol %. If only a single alkali metal oxide is present in the glass, the above upper limits may apply individually to each alkali metal oxide. If two or more alkali metal oxides are present, the above upper limits apply correspondingly to any combination. Some variants of the glasses are free of alkali metals aside from typical impurities, i.e. free of the alkali metal oxides Li₂O and/or Na₂O and/or K₂O, in particular free of Li₂O, Na₂O, K₂O, Cs₂O and/or Rb₂O.

With regard to the glass composition, it may be advantageous when particular sum totals and/or ratios of the glass components are satisfied individually or in combination:

The sum total of the components SiO₂+ZrO₂+Nb₂O₅+TiO₂+Ta₂O₅ may optionally be in the range of >10.5 to 28.0 mol %. It is thus firstly possible to improve hydrolytic stability and secondly to keep the risk of crystallization low. The viscosity of the glass is also improved. Some variants may have an exemplary lower limit of 12.0 mol % or of 14.0 mol % or of 15.5 mol % and/or have an upper limit of 26.0 mol % or of 24.0 mol %. In some variants, the range may be 15.5 mol % to 23.0 mol %.

The sum total of the components SiO₂+B₂O₃ may optionally be in the range of >40.5 to 55.0 mol %. It is thus firstly possible to improve hydrolytic stability and secondly to keep the sealing temperature low. Some variants may have a lower limit of 42.0 mol % or of 43.0 mol % and/or have an upper limit of 53.0 mol % or 51.0 mol %. In some variants, the range may be 42.0 mol % to 53.0 mol %.

The ratio of the components (SiO₂+Al₂O₃)/B₂O₃ may optionally be 0.70 to 1.70. In this way, the sealing temperature can be kept low. Some variants may have a lower limit of 0.75 or of 0.80 and/or have an upper limit of 1.60 or of 1.50 or of 1.30 or of 1.20. For some variants, the range may be 0.80 to 1.20 or 0.85 to 1.10.

The ratio of the components (SiO₂+Al₂O₃)/(B₂O₃+RO) may optionally be 0.30 to 0.90. In this way, the sealing temperature can be kept low and the viscosity of the glass can be improved. Some variants may have a lower limit of 0.35 or of 0.40 and/or have an upper limit of 0.80 or of 0.70 or of 0.65. In some variants, the range may be 0.35 to 0.70.

The ratio of the components (SiO₂+Al₂O₃+Nb₂O₅+ZrO₂+TiO₂+Ta₂O₅)/(B₂O₃+RO) may optionally be 0.35 to 0.90. It is thus firstly possible to improve hydrolytic stability and secondly to keep the risk of crystallization low. The viscosity of the glass is also improved. Some variants may have a lower limit of 0.37 or of 0.40 and/or have an upper limit of 0.80 or of 0.75 or of 0.70 or of 0.65. In some variants, the range may be 0.35 to 0.75.

The ratio of the components (SiO₂)/(Nb₂O₅+ZrO₂+TiO₂+Ta₂O₅) is more than 3.00. An exemplary range may be >3.00 to 55.00. As a result, there is a balanced ratio of the components in the glass which, in the context of the invention, improve chemical stability, in particular hydrolytic stability, but also increase the risk of crystallization. The viscosity of the glass is also improved. In some embodiments, the ratio may be less than 55.00, optionally less than 50.00, or less than 45.00. In some variants, the ratio may be not more than 40.00 or not more than 35.00.

The glass composition is optionally free of the following elements or compounds thereof: Cr, Ni, Cd, Pb, Hg, As, Sb, Be, Ag, Sn, Cd, Tl, because these are toxic and/or potentially allergenic. In addition, the glass may have low levels of alkali metals, where the sum total of the alkali metal oxides (Li₂O+Na₂O+K₂O+Cs₂O+Rb₂O) is optionally less than 0.5 mol %. The glass is optionally free of alkali metals (free of R₂O).

Expressions such as “Pb-free or lead-free”, “alkali metal-free” or quite generally “free of a component x” in the context of the present invention should be considered to mean that these substances or their oxides are not intentionally added to the glass as a component and are present in the glass in traces at most or as small residual amounts, i.e. as impurities at most. For lead, for example, this means that the Pb content is less than 1000 ppm. For example, the Pb content may be less than 500 ppm, optionally less than 100 ppm. For example, for Li₂O, Na₂O, K₂O, Cs₂O, Rb₂O and/or other components, some of which are described above with “free of”, the content per component may be less than 1000 ppm or less than 500 ppm, optionally less than 100 ppm, optionally less than 50 ppm.

In some embodiments, the glass consists to an extent of at least 94.0 mol %, optionally to an extent of at least 95.0 mol %, optionally to an extent of at least 97.0 mol %, in some variants to an extent of at least 99.0 mol %, of the components La₂O₃, B₂O₃, SiO₂, Al₂O₃, Nb₂O₅, ZrO₂, TiO₂, Ta₂O₅ and RO.

In some embodiments, the glass is free of components not mentioned in the disclosure.

In some embodiments, the glass may have the following components in mol % based on oxide:

| | |
|---|---|
| B₂O₃ | 22.5 to 36.0 |
| La₂O₃ | 1.0 to 11.0 |
| Al₂O₃ | 7.0 to 17.0 |
| SiO₂ | 10.5 to 23.0 |
| MgO + CaO + SrO | 30.0 to 39.5 |
| Nb₂O₅ + ZrO₂ + TiO₂ + Ta₂O₅ | 0.1 to 6.0 |

The glass may optionally include—in the context of the abovementioned limits for the sum total of Nb₂O₅+ZrO₂+TiO₂+Ta₂O₅—individually or in any combination, the following components in mol %:

| | |
|---|---|
| Nb₂O₅ | 0.0 to 6.0 |
| ZrO₂ | 0.0 to 6.0 |
| TiO₂ | 0.0 to 6.0 |
| Ta₂O₅ | 0.0 to 6.0 |

The glass may optionally include—in the context of the abovementioned limits for Al₂O₃ and for the sum total of MgO+CaO+SrO—individually or in any combination, the following components in mol %:

| | |
|---|---|
| Al₂O₃ | 7.0 to 17.0 |
| MgO | 0.0 to 20.0 |
| CaO | 0.0 to 20.0 |
| SrO | 0.0 to 10.0 |

In some embodiments, the glass may have the following components in mol % based on oxide, individually or in any combination, within the limits mentioned:

| | |
|---|---|
| B₂O₃ | 22.5 to 36.0 |
| La₂O₃ | 1.0 to 11.0 |
| Al₂O₃ | 7.0 to 16.0 |
| SiO₂ | 10.5 to 22.5 |
| ZrO₂ | 0.0 to 5.0 |
| TiO₂ | 0.0 to 5.0 |
| Nb₂O₅ | 0.0 to 5.0 |
| MgO | 0.0 to 18.0 |
| CaO | 0.0 to 19.0 |
| SrO | 0.0 to 8.0 |

The glass may optionally contain less than 3% by weight of fillers. Fillers are frequently used to adjust expansion characteristics, i.e. the CTE, of the glass to the metal components used in the electrical feedthrough. The glass optionally contains less than 1% by weight or less than 0.5% by weight of fillers. The glass is optionally free of fillers. The glass which has a defined content of particular components acting as stability enhancers and a particular proportion of SiO₂, in the context of the disclosure, has a CTE matched to titanium and titanium alloys even without fillers, such that no fillers are required for expansion matching.

With regard to the coefficient of thermal expansion (CTE) of the glass, it may be the case that the glass of the insulation material has a CTE (20° C.; 300° C.) in the range from 5.0 to 13.0 ppm/K, optionally in the range from 5.0 to 10.5 ppm/K, optionally in the range from 6.0 to 10.5 or 6.0 to 9.0 ppm/K, optionally in the range from 6.5 to 8.0 ppm/K. The inventors have recognized that it is possible through a specific selection of the glass components to provide a glass with high hydrolytic stability, which also has a CTE without fillers that is suitable for a glass-metal feedthrough comprising titanium or a titanium alloy. This was surprising. It is possible in particular in this way to achieve material coordination with titanium or titanium alloys, which can in turn improve the seal tightness of the feedthrough, in particular hermetic tightness. The CTE is determined by dilatometry in a static measurement (with a push rod dilatometer) according to ISO 7991:1987-12.

The glass of the insulation material may have a density in the range of 2.50 to 3.80 g/cm³, optionally in the range of 2.70 to 3.70 g/cm³, especially in the range of 2.80 to 3.50 g/cm³. Density can be determined in a known manner, e.g. according to ASTM C693: 1993.

It may also be the case that the glass of the insulation material has a glass transition temperature T_{g} which is lower than 750° C., optionally lower than 700° C., optionally lower than 670° C., optionally lower than 650° C. Transformation temperature is determined in a known manner according to DIN ISO 7884-8:1998-02.

In particular, the glass of the insulation material may have a glass transition temperature T_{g} which is in the range of 500 to 700° C., optionally in the range of 560 to 670° C., especially in the range of 600 to 650° C. In principle, a lower glass transition temperature T_{g} may be advantageous with regard to processing.

The glass of the insulation material may have a sphere temperature of not more than 850° C., optionally not more than 820° C., optionally not more than 790° C.

The glass of the insulation material may have a hemisphere temperature of not more than 900° C., optionally not more than 880° C., optionally not more than 870° C., optionally not more than 860° C.

The glass properties “sphere temperature” and “hemisphere temperature” were determined using the established method of heating microscopy (EHM) with an EMI301 heating microscope from “Hesse Instruments” with the “EMI III Heating Microscope Software”. The evaluation is effected automatically, for example according to DIN 51730, by analyzing the shadow profile of a sample. The hemisphere temperature signifies the temperature at which an originally cylindrical specimen has melted to form a hemisphere mass. The hemisphere temperature of the glass corresponds roughly to the temperature at which a tight glass-metal feedthrough can be produced, i.e. roughly to the sealing temperature. The sealing temperature may be 5° C. to 70° C. higher than the hemisphere temperature.

The main body of the feedthrough, also referred to as outer conductor, comprises titanium or a titanium alloy, where the material may be selected from grade 1 titanium, grade 2 titanium, grade 3 titanium, grade 4 titanium or grade 5 titanium, in particular a TiAl6V4 alloy. Titanium and titanium alloys may have a coefficient of thermal expansion CTE (20;300) in the range of 8 to 10 ppm/K, optionally in the range of 8.5 to 9.5 ppm/K.

The electrical conductor of the feedthrough may include or consist of a metal. The metal is optionally selected from Kovar, molybdenum, nickel, nickel-iron alloy, titanium, titanium alloy, platinum, platinum alloy (e.g. a Pt/Ir alloy), tantalum, tantalum alloy, niobium, niobium alloy.

The electrical conductor may have a coefficient of thermal expansion CTE (20;300) in the range of 5 to 13 ppm/K, optionally in the range of 6 to 10 ppm/K, optionally in the range of 7 to 9 ppm/K. In combination with a main body comprising or composed of titanium or a titanium alloy, matched sealing can be provided through appropriate choice of the insulation material.

In the case of matched sealing, it may be preferable when any difference in coefficients of expansion between main body and insulation material, optionally between main body, insulation material and conductor, is less than 5%.

In particular, a matched feedthrough is understood to mean that the coefficients of expansion differ essentially by not more than 1*10⁻⁶ l/K, and in particular are essentially equal.

In some embodiments, in conjunction with a main body comprising titanium or a titanium alloy, a compression seal can be provided, which can increase mechanical robustness. A chosen coefficient of thermal expansion of the main body is greater here than a coefficient of thermal expansion of the insulation material, such that, after a thermal treatment in which the insulation material is sealed into the through-opening, the main body is subject to more significant contraction than the insulation material. As a result, compressive forces are permanently exerted by the main body on the insulation material. These prestress the insulation material and ensure a particularly stable seal.

It may be accordingly preferable that a coefficient of thermal expansion of the main body is greater than a coefficient of thermal expansion of the insulation material. Optionally, in a compression seal, the chosen coefficient of thermal expansion of the main body is at least 5%, optionally at least 10%, optionally at least 20% and optionally at least 50% greater than the coefficient of thermal expansion of the insulation material.

The prestress for the compression seal is determined essentially by the difference in the coefficient of expansion between the material of the main body and the material of the insulation material.

To the extent that values for the coefficient of expansion have been given above in association with a compression seal or a matched seal for materials, these refer to the linear coefficient of thermal expansion a in the temperature interval of 20-300° C. which is typically reported in association with glass-metal feedthroughs.

For production of a feedthrough, the glass-comprising insulation material or a precursor material can be provided in the form of a shaped body. For example, the shaped body may take the form of a hollow cylinder. The electrical feedthrough is formed by inserting the electrical conductor into the interior of this hollow cylinder and inserting the latter in turn into a through-opening in a main body comprising or consisting of titanium or a titanium alloy. By a thermal treatment, the metal pin is then sealed into the opening, where the insulation material, in particular the glass, enters into an intimate bond with the material of the conductor and the material of the main body, so as to form a glass-metal feedthrough. The glass melts in the course of the thermal treatment.

In some cases, the use of titanium or titanium alloys in relation to chemical reactions can result in the special circumstance that the glass component SiO₂ reacts with titanium to form titanium silicide, with the result that detachment phenomena can occur at the glass-metal contact zone. This problem can be reduced or avoided in particular by virtue of the above figures relating to the glass composition. In particular, the aforementioned figures relating to B₂O₃ can result in suppression of this reaction and can lead to a TiB layer that leads to more chemically and mechanically stable bonds between a titanium-containing component and the glass.

It is a fundamental consideration that titanium or titanium alloys are highly reactive. With the glass compositions provided according to the invention, it is possible to reduce or avoid reaction of the titanium (alloys) with SiO₂ to form titanium silicide when the conductor is sealed into the main body (for example at sealing temperatures of 700 to 900° C.), and this reaction is accompanied, for example, by blistering at the interface. Moreover, with the glasses provided according to the invention, the sealing temperatures chosen can be lower, in order to be able to produce the glass-metal feedthroughs below the temperature range of the α/β phase transition of titanium.

In some embodiments, the feedthrough may have exactly one electrical conductor that extends through the insulation material accommodated in the through-opening.

In some embodiments, the feedthrough may have a plurality of electrical conductors which extend through the insulation material accommodated in the through-opening, for example at least 2 electrical conductors, optionally at least 10 electrical conductors.

The main body may comprise a plurality of through-openings with insulation material accommodated in each, where at least one, in particular exactly one, electrical conductor extends through the insulation material of each through-opening.

The main body comprising titanium or a titanium alloy may be plate-shaped. The main body may have a first and an opposite second surface, where the through-opening forms an inner wall which connects the first to the second surface. The main body may define a plane that runs parallel to the first and/or second surface. The main body, in a direction that runs parallel to the first and/or second surface and/or in the aforementioned plane, may have a dimension greater than the diameter of the through-opening, in particular at least twice as large, in particular at least three times as large.

The insulation material present in the through-opening may be set back relative to the first and/or second surface of the main body. In other words, the insulation material may be accommodated in the through-opening such that a step exists relative to the main body at the site of the inner wall. Alternatively, it may also be flush or even project beyond one surface of the main body or both surfaces of the main body.

The conductor may protrude with respect to the first and/or second surface of the main body.

A further aspect of the invention relates to a glass, in particular for an electrical feedthrough having a main body of titanium or a titanium alloy provided according to the invention, wherein the glass is a lanthanum borate glass comprising the following components (in mol % based on oxide):

| | |
|---|---|
| B₂O₃ | 22.0-37.0 |
| La₂O₃ | 1.0-12.0 |
| SiO₂ | 10.5-23.0 |
| RO (MgO + CaO + SrO) | 29.0-45.0 |
| Nb₂O₅ + ZrO₂ + TiO₂ + Ta₂O₅ | 0.1-6.0 |
| SiO₂/(Nb₂O₅ + ZrO₂ + TiO₂ + Ta₂O₅) | >3.00; |

where the glass, on determination of hydrolytic stability in accordance with DIN ISO 720:2021-12, has an Na₂O equivalence value of <1250 μg/g.

The components mentioned are glass components. In other words, at least one component of (Nb₂O₅+ZrO₂+TiO₂+Ta₂O₅) is part of the molten glass.

Details of the benefits of the glass composition according to the invention, of its advantageous developments, of advantageous chemical and physical properties, etc. have already been described above in association with the description of the feedthrough provided according to the invention. This disclosure is fully incorporated into the description of the further aspect of the invention. Reference is made thereto for avoidance of repetition.

The glass and an electrical feedthrough produced therewith can be used in electrical devices, medical devices, in particular in association with autoclavable feedthroughs having metal components composed of titanium or a titanium alloy. An advantageous field of use is endoscopes and surgical instruments that are used for examination, operation and treatment and are only briefly in contact with the body, but can be reused for such purposes more often after appropriate sterilization, for example devices in robot surgery. Another field of use is implantable medical devices or body-wearable devices, e.g. wearables. Since components made of titanium and titanium alloys are frequently used in fields such as aerospace, motor racing, etc. because of their exceptional strength, stability and low weight, the glass and the joins and feedthroughs produced therewith can also be used therein.

A further aspect of the invention thus relates to the use of a feedthrough provided according to the invention or of a glass provided according to the invention in a feedthrough or joint with a metal component composed of titanium or a titanium alloy in the fields of medical devices, wearables, aerospace, motor racing.

It will be apparent that the features of the invention—which comprises several aspects—that are mentioned above and still to be elucidated hereinafter are usable not just in their particular combination specified but also in other combinations, without leaving the scope of the invention.

The invention is elucidated in greater detail below by figures and a few working examples.

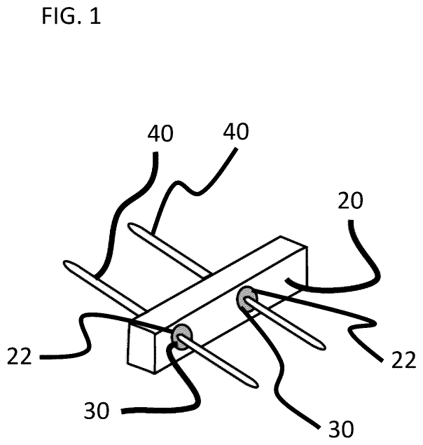

Referring to FIG. 1, a feedthrough having long-term autoclavability has an outer main body 20 through which one or more through-openings 22 (two here) run, with an insulation material 30 comprising or consisting of glass, through which at least one electrical conductor 40 extends, inserted in each through-opening 22. The conductor may project out of the insulation material on one side or on both sides (here on both sides). The feedthrough shown has two inner conductors (pins) and can therefore be referred to as a 2-pole feedthrough. It is possible that the main body 20 serves as an external conductor and thus forms a further electrical conductor. Of course, feedthroughs with only one inner conductor (pin) are also possible, i.e. simple feedthroughs or 1-pole feedthroughs.

In this example, the main body 20 is composed of titanium; it could alternatively be a titanium alloy. The conductors 40 here are likewise composed of titanium. Alternatively, however, they could also be composed of another biocompatible material, for example titanium alloy, Kovar, molybdenum, nickel-iron alloy, nickel, tantalum, tantalum alloy, niobium, niobium alloy, platinum, platinum alloy. The insulation material 30 consists of an alkaline earth metal oxide-containing lanthanum borate glass provided according to the invention.

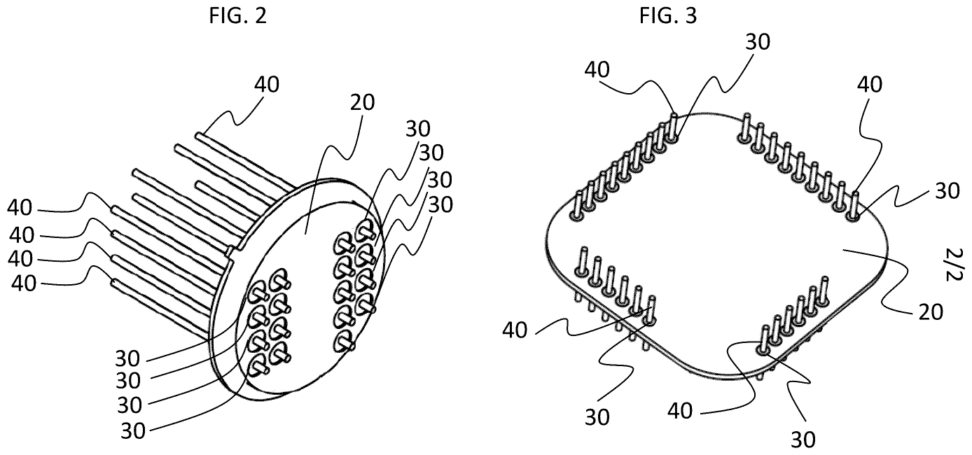

Referring to FIGS. 2 and 3, a feedthrough having long-term autoclavability may also have a plurality of inner conductors (pins), such that, for example, a 17-pole feedthrough (FIG. 2) or a 30-pole feedthrough (FIG. 3) may be provided. In the plug connectors shown, each individual inner conductor 40 extends through the insulation material of a single through-opening 22. However, it is also possible that a plurality or multitude of electrical conductors extend through the same insulation material of the same through-opening 22.

### EXAMPLES

Glasses with compositions according to Tables 1 and 2 were melted from conventional raw materials at temperatures above 1350° C. in heated Pt or Pt/Ir crucibles. The melt was kept at that temperature for more than 20 minutes, stirred for homogenization and cast into blocks.

In addition to the composition, the following parameters and properties of the glasses of the embodiments provided according to the invention (Ex.) and of the comparative examples (CEx.) were determined on bulk samples by the methods as described above: CTE (20;300), density, T_{g}.

For production of a glass powder, the melt can be passed through water-cooled metal rollers and the glass ribbon can then be ground.

The pure powders were used to produce compressed samples in a known manner and, for characterization of softening characteristics, melting characteristics etc. of the glasses, characteristic points were determined by heating microscopy (EHM) by the method as described above: sphere temperature, hemisphere temperature.

The glass powders were used to produce hollow cylindrical shaped bodies in a known manner for the production of electrical feedthroughs. An electrical feedthrough was formed in each case by inserting an electric conductor composed of titanium into the interior of a hollow cylinder and inserting the latter in turn into a through-opening of a main body made of titanium. By a thermal treatment, the metal pin was then sealed into the opening by melting the glass, which entered into an intimate bond with the material of the conductor and the material of the main body, so as to form a glass-metal feedthrough in each case. The temperature at which hermetically sealed feedthroughs can be successfully produced is the sealing temperature.

After production of the feedthroughs, i.e. before the first autoclaving operation, insulation resistance at the feedthroughs with sealed conductors was measured by the method (MIL-STD-883, Meth. 1003) as described at the outset. The diameter of the through-opening in the main body was 1.8 mm, the diameter of the conductor was 0.5 mm, and the sealing length was 3.0 mm.

Long-term autoclaving stability was then determined on the feedthroughs as follows: The feedthroughs were placed in a Petri dish on a grid in an autoclave. This is possible on multiple rails. The fixed autoclaving sequence was then started with the parameters of 135.5° C., 2.16 bar, 20 min. The feedthroughs remained therein for at least 300 cycles. Each cycle comprises the following phases: removal of air from the sterilization chamber; steam generation; sterilization phase (at 135.5° C. and pressure 2.16 bar for 20 min); vacuum drying; removal of service water from the circuit; pressure equalization in the sterilization chamber up to air pressure and active cooling to room temperature (end of cycle). After the first 300 cycles, the insulation resistance at the feedthroughs was measured again. If the insulation resistance was still at least 1×10⁹ ohms, the feedthroughs were autoclaved for another 300 cycles and then the insulation resistance was measured again. In feedthroughs comprising the glasses provided according to the invention (Ex. 1-4, 12-14), the tests were stopped after 1200 cycles, since the insulation resistance was still above the required minimum resistance.

Known glasses (CEx. A-C) that can be used in feedthroughs in implantable devices were likewise used to produce corresponding feedthroughs, which were tested under the same conditions. The tests were stopped after 300 autoclaving cycles since the measured insulation resistance was less than 1*10⁹ ohms.

In addition, the helium leakage rate at the feedthroughs was determined after completion or termination of the autoclaving cycles.

Table 1 shows 14 working examples (Ex.) of the invention, while Table 2 lists comparative examples (CEx.).

TABLE 1
Working examples (Ex. 1 to 7, in mol %)

| Ex. No. | 1 | 2 | 3 | 4 | 5 | 6 | 7 |
|---|---|---|---|---|---|---|---|
| B₂O₃ | 30.3 | 29.5 | 30.2 | 30.2 | 35.0 | 22.5 | 28.2 |
| CaO | 18.8 | 16.0 | 15.6 | 14.7 | 14.7 | 15.0 | 14.5 |
| MgO | 15.1 | 13.7 | 14.6 | 13.7 | 13.6 | 12.0 | 13.7 |
| SrO | 5.5 | 5.3 | 5.5 | 5.0 | 4.5 | 5.3 | 5.0 |
| La₂O₃ | 5.0 | 4.9 | 5.0 | 5.0 | 4.5 | 5.3 | 10.0 |
| SiO₂ | 10.6 | 17.6 | 16.5 | 16.5 | 16.0 | 22.0 | 16.5 |
| Al₂O₃ | 14.6 | 12.0 | 12.0 | 12.0 | 10.8 | 12.5 | 11.8 |
| Nb₂O₅ | 0.2 | 1.0 | | | 1.0 | 2.0 | |
| ZrO₂ | | | 0.6 | 3.0 | | 1.8 | 0.2 |
| TiO₂ | | | | | | 1.5 | 0.2 |
| Total | 100.0 | 100.0 | 100.0 | 100.0 | 100.0 | 100.0 | 100.0 |
| SiO₂ + B₂O₃ | 40.9 | 47.1 | 46.7 | 46.7 | 51.0 | 44.5 | 44.7 |
| RO | 39.4 | 35.0 | 35.7 | 33.4 | 32.8 | 32.3 | 33.2 |
| ZrO₂ + Nb₂O₅ + TiO₂ + Ta₂O₅ | 0.2 | 1.0 | 0.6 | 3.0 | 1.0 | 5.3 | 0.4 |
| SiO₂ + Nb₂O₅ + ZrO₂ + TiO₂ + Ta₂O₅ | 10.8 | 18.6 | 17.1 | 19.5 | 17.0 | 27.3 | 16.9 |
| (SiO₂ + Al₂O₃)/B₂O₃ | 0.83 | 1.00 | 0.94 | 0.94 | 0.77 | 1.53 | 1.00 |
| (SiO₂ + Al₂O₃)/(B₂O₃ + RO) | 0.36 | 0.46 | 0.43 | 0.45 | 0.40 | 0.63 | 0.46 |
| (SiO₂ + Al₂O₃)/ | 0.71 | 0.86 | 0.81 | 0.81 | 0.68 | 1.24 | 0.74 |
| (B₂O₃ + La₂O₃) | | | | | | | |
| (SiO₂ + Al₂O₃ + Nb₂O₅ + ZrO₂ + TiO₂ + | 0.36 | 0.47 | 0.44 | 0.50 | 0.41 | 0.73 | 0.47 |
| Ta₂O₅)/(B₂O₃ + RO) | | | | | | | |
| (SiO₂)/(Nb₂O₅ + ZrO₂ + TiO₂ + Ta₂O₅) | 53.00 | 17.60 | 27.50 | 5.50 | 16.00 | 4.15 | 41.25 |
| Properties | | | | | | | |
| CTE (20-300), ppm/K | 7.6 | 7.2 | 7.4 | 7.1 | 6.8 | 6.8 | 8.0 |
| T_{g}, ° C. | 626 | 632 | 626 | 640 | 642 | 642 | 648 |
| Density, g/cm3 | 3.21 | 3.20 | 3.19 | 3.22 | 3.04 | 3.04 | 3.57 |
| Sphere temp., ° C. | 750 | 765 | 764 | 779 | 779 | | |
| Hemisphere temp., ° C. | 843 | 847 | 831 | 832 | 837 | | |
| Sealing temp., ° C. | 880 | 850 | 850 | 850 | | | |
| Autoclaving cycles/AC | 1200 | 1200 | 1200 | 1200 | | | |
| (number) | | | | | | | |
| Insulation resistance, ohms | 2.00*10¹¹ | 1.00*10¹¹ | 1.00*10¹¹ | >1*10¹¹ | | | |
| (before autoclaving) | | | | | | | |
| Insulation resistance, ohms | 2.00*10¹¹ | 2.00*10¹⁰ | 5.00*10⁹ | 1.00*10¹¹ | | | |
| (after AC number) | | | | | | | |
| Seal tightness (helium | <1*10⁻⁸ | <1*10⁻⁸ | <1*10⁻⁸ | <1*10⁻⁸ | | | |
| leakage rate), | | | | | | | |
| mbar l s⁻¹ | | | | | | | |
| Na₂O equivalent, μg/g | 1240 | 786 | 842 | 790 | | | |
| (to DIN ISO720) | | | | | | | |

TABLE 1
Working examples (Ex. 8 to 14, in mol %)

| Ex. No. | 8 | 9 | 10 | 11 | 12 | 13 | 14 |
|---|---|---|---|---|---|---|---|
| B₂O₃ | 33.0 | 30.0 | 30.0 | 30.0 | 29.7 | 30.0 | 30.0 |
| CaO | 16.0 | 15.0 | 15.0 | 15.0 | 14.6 | 16.3 | 15.0 |
| MgO | 15.0 | 14.0 | 14.0 | 9.3 | 13.6 | 14.0 | 12.3 |
| SrO | 5.5 | 5.5 | 5.5 | 8.5 | 4.5 | 5.6 | 4.3 |
| La₂O₃ | 2.0 | 4.5 | 4.5 | 5.0 | 4.5 | 4.9 | 4.9 |
| SiO₂ | 12.0 | 14.0 | 14.0 | 13.0 | 21.0 | 18.6 | 17.6 |
| Al₂O₃ | 13.0 | 13.0 | 13.0 | 15.0 | 11.5 | 9.5 | 12.0 |
| Nb₂O₅ | | | | 3.5 | | 1.2 | 4.0 |
| ZrO₂ | 1.5 | | 3.5 | 0.8 | 0.6 | | |
| TiO₂ | 2.0 | 4.0 | 0.5 | | | | |
| Total | 100.0 | 100.0 | 100.0 | 100.0 | 100.0 | 100.0 | 100.0 |
| SiO₂ + B₂O₃ | 45.0 | 44.0 | 44.0 | 43.0 | 50.7 | 48.6 | 47.6 |
| RO | 36.5 | 34.5 | 34.5 | 32.8 | 32.7 | 35.9 | 31.6 |
| ZrO₂ + Nb₂O₅ + TiO₂ + Ta₂O₅ | 3.5 | 4.0 | 4.0 | 4.3 | 0.6 | 1.2 | 4.0 |
| SiO₂ + Nb₂O₅ + ZrO₂ + TiO₂ + Ta₂O₅ | 15.5 | 18.0 | 18.0 | 17.3 | 21.6 | 19.8 | 21.6 |
| (SiO₂ + Al₂O₃)/B₂O₃ | 0.76 | 0.90 | 0.90 | 0.93 | 1.09 | 0.94 | 0.99 |
| (SiO₂ + Al₂O₃)/(B₂O₃ + RO) | 0.36 | 0.42 | 0.42 | 0.45 | 0.52 | 0.43 | 0.48 |
| (SiO₂ + Al₂O₃)/ | 0.71 | 0.78 | 0.78 | 0.80 | 0.95 | 0.81 | 0.85 |
| (B₂O₃ + La₂O₃) | | | | | | | |
| (SiO₂ + Al₂O₃ + Nb₂O₅ + ZrO₂ + TiO₂ + | 0.41 | 0.48 | 0.48 | 0.51 | 0.53 | 0.44 | 0.55 |
| Ta₂O₅)/(B₂O₃ + RO) | | | | | | | |
| (SiO₂)/(Nb₂O₅ + ZrO₂ + TiO₂ + Ta₂O₅) | 3.43 | 3.50 | 3.50 | 3.02 | 35.00 | 15.50 | 4.40 |
| Properties | | | | | | | |
| CTE (20-300), ppm/K | 7.0 | 7.2 | 7.2 | 7.2 | 6.8 | 7.5 | 6.9 |
| T_{g}, ° C. | 627 | 634 | 634 | 640 | 639 | 632 | 630 |
| Density, g/cm3 | 2.87 | 3.11 | 3.10 | 3.41 | 3.11 | 3.23 | 3.28 |
| Sphere temp., ° C. | | | | | 785 | 767 | 780 |
| Hemisphere temp., ° C. | | | | | 850 | 836 | 858 |
| Sealing temp., ° C. | | | | | 850 | 850 | 850 |
| Autoclaving cycles/AC | | | | | 1200 | 1200 | 1200 |
| (number) | | | | | | | |
| Insulation resistance, ohms | | | | | >1*10¹¹ | >1*10¹¹ | >1*10¹¹ |
| (before autoclaving) | | | | | | | |
| Insulation resistance, ohms | | | | | 1.00*10¹¹ | 1.00*10¹⁰ | 1.00*10¹¹ |
| (after AC number) | | | | | | | |
| Seal tightness (helium | | | | | <1*10⁻⁸ | <1*10⁻⁸ | <1*10⁻⁸ |
| leakage rate), | | | | | | | |
| mbar l s⁻¹ | | | | | | | |
| Na₂O equivalent, μg/g | | | | | 700 | 840 | 600 |
| (to DIN ISO720) | | | | | | | |

TABLE 2
Comparative examples (CEx. A to C, in mol %)

| CEx. No. | A | B | C |
|---|---|---|---|
| B₂O₃ | 30.3 | 26.6 | 51.0 |
| CaO | 18.8 | 4.4 | 17.0 |
| MgO | 15.1 | | |
| SrO | 5.5 | | |
| La₂O₃ | 5.0 | | 15.0 |
| SiO₂ | 10.1 | 50.7 | |
| Al₂O₃ | 15.2 | 5.1 | 5.0 |
| Nb₂O₅ | | | |
| ZrO₂ | | | |
| TiO₂ | | | 12.0 |
| Na₂₀ | | 13.2 | |
| Total | 100.0 | 100.0 | 100.0 |
| SiO₂ + B₂O₃ | 40.4 | 77.3 | 15.0 |
| RO | 39.4 | 4.4 | |
| ZrO₂ + Nb₂O₅ + TiO₂ + Ta₂O₅ | | | 12.0 |
| SiO₂ + Nb₂O₅ + ZrO₂ + TiO₂ + Ta₂O₅ | 10.1 | 50.7 | 12.0 |
| (SiO₂ + Al₂O₃)/B₂O₃ | 0.83 | 2.10 | 1.33 |
| (SiO₂ + Al₂O₃)/(B₂O₃ + RO) | 0.36 | 1.80 | 1.00 |
| (SiO₂ + Al₂O₃)/(B₂O₃ + La₂O₃) | 0.71 | 2.10 | 1.03 |
| (SiO₂ + Al₂O₃ + Nb₂O₅ + ZrO₂ + TiO₂ + | 0.36 | 1.80 | 1.00 |
| Ta₂O₅)/(B₂O₃ + RO) | | | |
| (SiO₂)/(Nb₂O₅ + ZrO₂ + TiO₂ + Ta₂O₅) | | | |
| Properties | | | |
| CTE (20-300), ppm/K | 7.8 | 7.4 | 7.7 |
| T_{g}, ° C. | 620 | 535 | 653 |
| Density, g/cm3 | 3.20 | 2.41 | 3.83 |
| Sphere temp., ° C. | 746 | 716 | 729 |
| Hemisphere temp., ° C. | 845 | 799 | 800 |
| Sealing temp., ° C. | 900 | 820 | 870 |
| Autoclaving cycles/AC | 300 | 300 | 300 |
| (number) | | | |
| Insulation resistance, ohms | 1.00*10¹² | 1.00*10¹¹ | 1.00*10⁶ |
| (before autoclaving) | | | |
| Insulation resistance, ohms | 5.00*10⁸ | 1.00*10⁶ | 1.00*10⁶ |
| (after AC number) | | | |
| Seal tightness (He leakage | >1*10⁻⁸ | >1*10⁻⁸ | >1*10⁻⁸ |
| rate), mbar l s⁻¹ | | | |
| Na₂O equivalent, μg/g | 1200 | 1800 | 992 |
| (to DIN ISO720) | | | |

Examples 2 to 4 and 12 to 14, by comparison with Comparative Examples A to C, show lower Na₂O equivalence values, i.e. the glasses provided according to the invention have better hydrolytic stability. The Na₂O equivalence value in Examples 2-4 and 12-14 is less than 930 μg/g, i.e. these glasses are covered by class 3 according to DIN ISO 720. The improvement in hydrolytic stability is attributable to a relatively high proportion of SiO₂ for glass-metal feedthroughs comprising titanium or a titanium alloy and a particular proportion of stability enhancers selected from the group consisting of Nb₂O₅, ZrO₂, TiO₂, Ta₂O₅, where SiO₂ and stability enhancers are in a balanced ratio to one another.

The glasses provided according to the invention can be used to provide feedthroughs having long-term autoclaving stability in main bodies composed of titanium or a titanium alloy. While the required minimum insulation resistance of 1*10⁹ ohms is no longer attained even after 300 autoclaving cycles in the case of Comparative Examples A and B, the glasses of Examples 1 to 4, 12 to 14 can be used to produce feedthroughs having insulation resistance after 1200 autoclaving cycles that is still higher than 1*10⁹ ohms and a helium leakage rate of less than 1*10⁻⁸ mbar*l/s, i.e. the feedthrough according to the invention remains hermetically sealed even after more than 300 (here after 1200) autoclaving cycles, by contrast to the comparative feedthroughs with the glasses from Comparative Examples A to C.

In addition, the glasses provided according to the invention even without fillers have a CTE (20;300) appropriate for the production of hermetically sealed feedthroughs with main bodies composed of titanium or titanium alloys and conductors composed of the materials defined above.

Softening and melting characteristics are optimized in the glasses provided according to the invention in such a way that the sealing into titanium or titanium alloys can be carried out not too far above or, optionally, below the temperature range of the α/β phase transition of titanium. The hemisphere temperature of Examples 1 to 4 and 12 to 14 is less than 870° C., and so the sealing temperature chosen can be correspondingly low, in particular <930° C., optionally <900° C.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrical feedthrough, comprising:
a main body having at least one through-opening running through the main body and comprising titanium or titanium alloy;
an insulation material accommodated in the at least one through-opening running through the main body, the insulation material comprising a glass; and
at least one electrical conductor that extends through the insulation material accommodated in the at least one through-opening;
wherein the glass is a lanthanum borate glass comprising the following components (in mol % based on oxide):

| | |
|---|---|
| B₂O₃ | 22.0-37.0; |
| La₂O₃ | 1.0-12.0; |
| SiO₂ | 10.5-23.0; |
| RO (MgO + CaO + SrO) | 29.0-45.0; |
| Nb₂O₅ + ZrO₂ + TiO₂ + Ta₂O₅ | 0.1-6.0; and |
| SiO₂/(Nb₂O₅ + ZrO₂ + TiO₂ + Ta₂O₅) | >3.00; |

wherein the glass, on determination of hydrolytic stability in accordance with DIN ISO 720:2021-12, has an Na₂O equivalence value of <1250 μg/g, wherein the feedthrough has long-term autoclaving stability and an insulation resistance of the feedthrough after 300 autoclaving operations is at least 1*10⁹ ohms.

2. The electrical feedthrough of claim 1, wherein the feedthrough has a hermeticity characterized by a helium leakage rate of less than 1*10⁻⁸ mbar 1 s⁻¹ after 300 autoclaving operations.

3. The electrical feedthrough of claim 1, wherein the glass, individually or in any combination, comprises the following components in mol % based on oxide:

| | |
|---|---|
| Nb₂O₅ | 0.0-6.0; |
| ZrO₂ | 0.0-6.0; |
| TiO₂ | 0.0-6.0; and |
| Ta₂O₅ | 0.0-6.0. |

4. The electrical feedthrough of claim 1, wherein a sum total of the components SiO₂+ZrO₂+Nb₂O₅+TiO₂+Ta₂O₅ is within a range from >10.5 to 28.0 mol %.

5. The electrical feedthrough of claim 1, wherein the glass, individually or in any combination, comprises the following components in mol % based on oxide:

| | |
|---|---|
| Al₂O₃ | 7.0-17.0; |
| MgO | 0.0-20.0; |
| CaO | 0.0-20.0; and |
| SrO | 0.0-10.0. |

6. The electrical feedthrough of claim 1, wherein the SiO₂ content in the glass is at least 12.0 mol % and/or wherein the glass contains 7.0 to <15.0 mol of Al₂O₃.

7. The electrical feedthrough of claim 1, wherein the glass meets at least one of the following conditions:
the glass does not contain more than 1.5 mol % of BaO; or
the glass contains <3.0 mol % of alkali metal oxides (R₂O).

8. The electrical feedthrough of claim 1, wherein the glass meets at least one of the following conditions:
a coefficient of thermal expansion (20° C.; 300° C.) in a range from 5.0 to 13.0 ppm/K;
a glass transition temperature T_{g} which is lower than 750° C.; or
a hemisphere temperature of not more than 900° C.

9. The electrical feedthrough of claim 1, wherein a material of the main body is selected from grade 1 titanium, grade 2 titanium, grade 3 titanium, grade 4 titanium or grade 5 titanium, and/or the at least one electrical conductor comprises a material selected from the group consisting of Kovar, molybdenum, nickel, nickel-iron alloy, titanium, titanium alloy, platinum, platinum alloy (e.g. a Pt/Ir alloy), tantalum, tantalum alloy, niobium, and niobium alloy.

10. A glass for an electrical feedthrough having a main body of titanium or a titanium alloy, the glass being a lanthanum borate glass comprising the following components (in mol % based on oxide):

| | |
|---|---|
| B₂O₃ | 22.0-37.0; |
| La₂O₃ | 1.0-12.0; |
| SiO₂ | 10.5-23.0; |
| RO (MgO + CaO + SrO) | 29.0-45.0; |
| Nb₂O₅ + ZrO₂ + TiO₂ + Ta₂O₅ | 0.1-6.0; and |
| SiO₂/(Nb₂O₅ + ZrO₂ + TiO₂ + Ta₂O₅) | >3.00; |

where the glass, on determination of hydrolytic stability in accordance with DIN ISO 720:2021-12, has an Na₂O equivalence value of <1250 μg/g.

11. The glass of claim 10, wherein the glass, individually or in any combination, comprises the following components in mol % based on oxide:

| | |
|---|---|
| Nb₂O₅ | 0.0-6.0; |
| ZrO₂ | 0.0-6.0; |
| TiO₂ | 0.0-6.0; and |
| Ta₂O₅ | 0.0-6.0. |

12. The glass of claim 10, wherein a sum total of the components SiO₂+ZrO₂+Nb₂O₅+TiO₂+Ta₂O₅ is within a range from >10.5 to 28.0 mol %.

13. The glass of claim 10, wherein the glass, individually or in any combination, comprises the following components in mol % based on oxide:

| | |
|---|---|
| Al₂O₃ | 7.0-17.0; |
| MgO | 0.0-20.0; |
| CaO | 0.0-20.0; and |
| SrO | 0.0-10.0. |

14. The glass of claim 10, wherein the SiO₂ content in the glass is at least 12.0 mol % and/or wherein the glass contains 7.0 to <15.0 mol of Al₂O₃.

15. The glass of claim 10, wherein the glass meets at least one of the following conditions:
the glass does not contain more than 1.5 mol % of BaO; or
the glass contains <3.0 mol % of alkali metal oxides (R₂O).

16. The glass of claim 10, wherein the glass meets at least one of the following conditions:
a coefficient of thermal expansion (20° C.; 300° C.) in a range from 5.0 to 13.0 ppm/K;
a glass transition temperature T_{g} which is lower than 750° C.; or
a hemisphere temperature of not more than 900° C.

17. A use of the glass of claim 10 in a feedthrough or a joint with a metal component made of titanium or a titanium alloy in the field of medical devices, wearables, aerospace, or motor racing.
